(19) United States
(12) Patent Application Publication
(10) Pub. No.: US 2016/0259282 A1
(43) Pub. Date: Sep. 8, 2016

(54) FIXING DEVICE AND IMAGE FORMING APPARATUS

(71) Applicant: FUJI XEROX CO., LTD., Tokyo (JP)

(72) Inventors: Nobuyoshi KOMATSU, Ebina-shi (JP); Masaki NAGATA, Ebina-shi (JP); Motoi NOYA, Ebina-shi (JP); Yusuke KANAI, Ebina-shi (JP)

(73) Assignee: FUJI XEROX CO., LTD., Tokyo (JP)

(21) Appl. No.: 14/842,901

(22) Filed: Sep. 2, 2015

(30) Foreign Application Priority Data
Mar. 4, 2015 (JP) 2015-042379

(51) Int. Cl. G03G 15/20

(52) U.S. Cl. CPC G03G 15/2089

(57) ABSTRACT

A fixing device includes a pressure applying unit that is provided facing a heating unit. The pressure applying unit includes an endless belt-shaped member that rotates by being driven by rotation of the heating unit, and a retainer that retains the endless belt-shaped member in a movable manner. The retainer has an upstream adjuster that is located at an upstream side of the endless belt-shaped member in a rotational direction thereof and that has a curved shape with a center, in a longitudinal direction of the retainer, which is a most bulging area from which the upstream adjuster decreases in height toward opposite ends of the upstream adjuster.

### CROSS-REFERENCE TO RELATED APPLICATIONS

This application is based on and claims priority under 35 USC 119 from Japanese Patent Application No. 2015-042379 filed Mar. 4, 2015.

### BACKGROUND

### Technical Field

The present invention relates to fixing devices and image forming apparatuses.

### SUMMARY

According to an aspect of the invention, there is provided a fixing device including a pressure applying unit that is provided facing a heating unit. The pressure applying unit includes an endless belt-shaped member that rotates by being driven by rotation of the heating unit, and a retainer that retains the endless belt-shaped member in a movable manner. The retainer has an upstream adjuster that is located at an upstream side of the endless belt-shaped member in a rotational direction thereof and that has a curved shape with a center, in a longitudinal direction of the retainer, which is a most bulging area from which the upstream adjuster decreases in height toward opposite ends of the upstream adjuster.

### BRIEF DESCRIPTION OF THE DRAWINGS

An exemplary embodiment of the present invention will be described in detail based on the following figures, wherein:

FIG. 1 is a cross-sectional view illustrating an image forming apparatus according to an exemplary embodiment;

FIG. 2 is a cross-sectional view illustrating a fixing device according to an exemplary embodiment;

FIG. 3 is a partially enlarged view of the fixing device according to the exemplary embodiment shown in FIG. 2;

FIG. 4 is a perspective view schematically illustrating a part of a retainer;

FIG. 5A is a plan view as viewed along an arrow VA in FIG. 3, and FIG. 5B is a front view as viewed along an arrow VB in FIG. 3;

FIG. 6 is a plan view that schematically illustrates the behavior of an endless belt and corresponds to FIG. 5A; and

FIG. 7A is a perspective view that illustrates another example of the retainer and corresponds to FIG. 4, and FIG. 7B is a perspective view that illustrates yet another example of the retainer and corresponds to FIG. 4.

### DETAILED DESCRIPTION

An exemplary embodiment of the present invention will be described below with reference to the drawings. However, the following exemplary embodiment is only an example of a fixing device and an image forming apparatus for realizing the technical idea of the present invention and is not intended to limit the present invention. The present invention may be equally applied to other exemplary embodiments included in the scope of the claims.

### Exemplary Embodiment

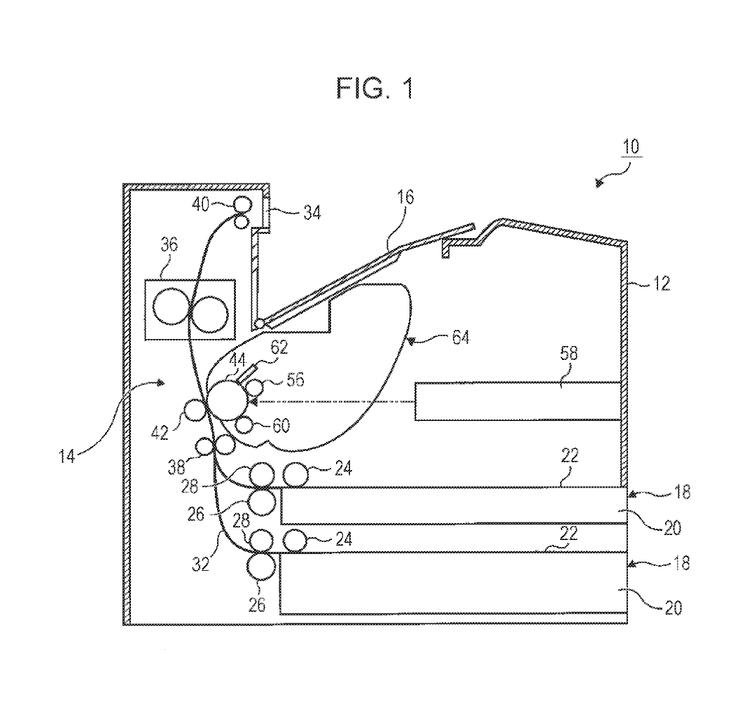

An image forming apparatus 10 according to an exemplary embodiment will now be described with reference to FIGS. 1 to 5B. As shown in FIG. 1, the image forming apparatus 10 according to the exemplary embodiment has an image-forming-apparatus body 12. At least one sheet feed unit 18, an image forming unit 14, and a fixing device 36 are installed inside the image-forming-apparatus body 12. The image-forming-apparatus body 12 has an output port 34 at an upper portion thereof and is provided with a transport path 32, which extends through the image-forming-apparatus body 12 and along which a recording medium 144, such as a recording sheet, as a transfer medium is transported. Furthermore, as will be described later, the image forming apparatus 10 according to the exemplary embodiment is of a free-belt-nip-fusing (FBNF) type having two pressing members with different hardness in a pressing unit as a pressure applying unit provided in the fixing device 36. Each of the above components will be described below.

The sheet feed unit 18 is provided with a sheet-feed-unit body 20, a sheet feed cassette 22 that accommodates recording media 144 as transfer media, a pickup roller 24 that pulls out the recording media 144 stacked in the sheet feed cassette 22, and a feed roller 28 and a retardation roller 26 that feed the recording media 144 while separating them from each other. When the pickup roller 24, the feed roller 28, and the retardation roller 26 rotate, each of the recording media 144 stacked in the sheet feed cassette 22 is transported to a registration roller 38, which will be described later, along the transport path 32. The sheet feed cassette 22 is detachably attached to the sheet-feed-unit body 20. The sheet feed unit 18 may be a single sheet feed unit or may include multiple sheet feed units. In the exemplary embodiment, two sheet feed units 18 are provided, as shown in FIG. 1.

The image forming unit 14 is of an electrophotographic type and includes an image bearing member 44 formed of a photoconductor; a charging device 56 formed of, for example, a charging roller that uniformly charges the image bearing member 44; an optical write device 58 that optically writes a latent image onto the image bearing member 44 charged by the charging device 56; a developing device 60 having a developing roller that develops the latent image formed on the image bearing member 44 by the optical write device 58 into a visible image by using toner; a transfer device 42 formed of, for example, a transfer roller that transfers the toner image formed by the developing device 60 onto the recording medium 144; a cleaning device 62 that cleans off the toner remaining on the image bearing member 44; and the fixing device 36 that fixes the toner image transferred on the recording medium 144 by the transfer device 42 onto the recording medium 144.

The optical write device 58 is, for example, a scan-type laser exposure device that forms the latent image on the image bearing member 44 by moving across a process cartridge 64 to be described below. As another example, the optical write device 58 may be a light-emitting diode (LED) or a surface-emitting laser.

The process cartridge 64 is a single unit obtained by integrating the image bearing member 44, the charging device 56, the developing device 60, and the cleaning device 62, and this single unit is replaceable. The process cartridge 64 is removable from the image-forming-apparatus body 12 by opening an output section 16.

The transport path 32 is a path for the recording medium 144 and extends from the pickup roller 24 of the lower sheet feed unit 18 to the output port 34 at the upper portion of the image-forming-apparatus body 12. This transport path 32 has a substantially vertical segment that is located within the image-forming-apparatus body 12 and that extends from the pickup roller 24 of the lower sheet feed unit 18 to the fixing device 36.

In this transport path 32, the transfer device 42 and the image bearing member 44 are disposed upstream of the fixing device 36, and the registration roller 38 is disposed upstream of the transfer device 42 and the image bearing member 44. Furthermore, an output roller 40 is disposed near the output port 34 of the transport path 32.

Therefore, the recording medium 144 fed by the pickup roller 24 from the sheet feed cassette 22 of one of the sheet feed units 18 is separated by the retardation roller 26 and the feed roller 28, is guided to the transport path 32, is temporarily stopped by the registration roller 38, and undergoes a developer-image transfer process by passing between the transfer device 42 and the image bearing member 44 at a predetermined timing. Subsequently, this transferred developer image is fixed onto the recording medium 144 by the fixing device 36, and the recording medium 144 is then output from the output port 34 to the output section 16 by the output roller 40.

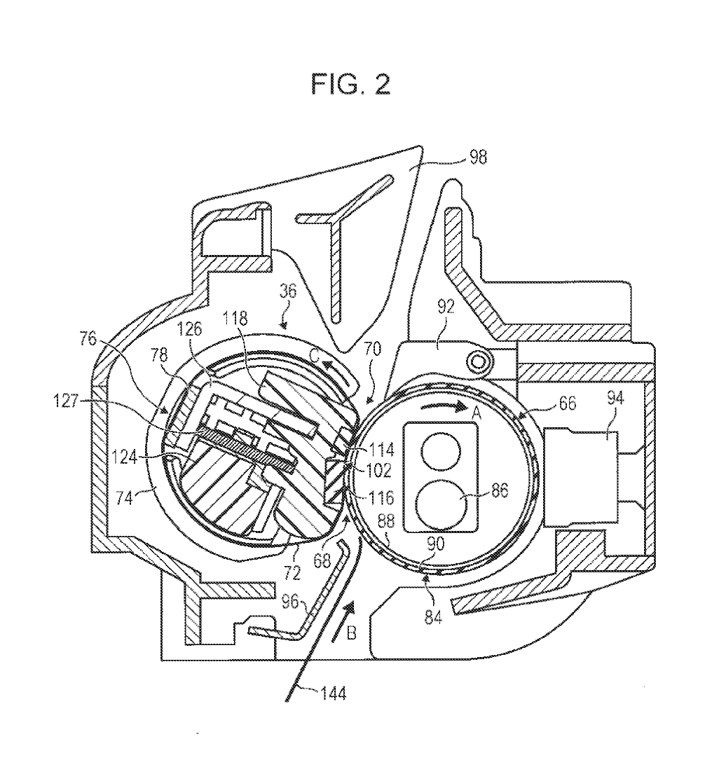

Next, the fixing device 36 according to the exemplary embodiment will be described with reference to FIGS. 2 to 5B. The fixing device 36 according to the exemplary embodiment includes a heating roller 66 as a heating member, an endless belt 72 as an endless belt-shaped member, a guide member 74 that guides the endless belt 72 in a rotatable manner, a pressing unit 76 as a pressure applying unit that is disposed within the endless belt 72 and that presses the endless belt 72 against the heating roller 66, and a saturated pad 78 that supplies a lubricant to the inner side of the endless belt 72.

The guide member 74 is disposed at opposite ends of the endless belt 72 and the pressing unit 76 and is supported by frames 126 and 127. A sliding sheet (not shown) for reducing friction between the endless belt 72 and the pressing unit 76 may be provided between the endless belt 72 and the pressing unit 76.

The heating roller 66 includes a cylindrical roller component 84 and a heater 86 disposed within this roller component 84. The roller component 84 is supported in a rotatable manner about a heating-roller bearing (not shown) and rotates in a direction indicated by an arrow A. Moreover, the roller component 84 is formed of a core 88 composed of a metallic material, such as iron, stainless steel, or aluminum, and a release layer 90 coated or applied over this core 88, and is a so-called hard roller not having an elastic layer. The core 88 has an outer dimension of, for example, 25 mm and a wall thickness of, for example, 0.7 mm. The release layer 90 is composed of a material with high insulating and release properties, such as perfluoroalkoxy (PFA), and has a thickness of, for example, 20 μm. Although the heating roller 66 is described as being a roller not having an elastic layer in this exemplary embodiment, an exemplary embodiment of the present invention is applicable to a roller having an elastic layer.

The roller component 84 is in abutment with multiple (e.g., five) peeling claws 92. The heater 86 is constituted of, for example, two lamps. A thermostat 94 is provided facing the heating roller 66 at a side of the heating roller 66 opposite the endless belt 72.

The heating roller 66 may have a flared shape. With a flared shape, the heating roller 66 transports the recording medium 144 while pulling opposite edges thereof, so that a pressing width of the heating roller 66 becomes larger at the opposite axial ends thereof than at the center thereof. Thus, the recording medium 144 becomes fetched starting from the opposite edges thereof, thereby suppressing the occurrence of, for example, creases in the recording medium 144.

The endless belt 72 is provided between the heating roller 66 and the pressing unit 76 and rotates in a direction indicated by an arrow C by being driven by the rotation of the heating roller 66. The heating roller 66 and the endless belt 72 are brought into pressure contact with each other by the pressing unit 76 so that a pressing area 102 is formed. The toner image is fixed onto the recording medium 144 in this pressing area 102. The endless belt 72 is composed of synthetic resin, such as polyimide, has a thickness of, for example, 75 μm.

An inlet chute 96 is provided upstream of the pressing area 102. The recording medium 144 transported in a direction indicated by an arrow B is guided to this inlet chute 96 so that the leading edge of the recording medium 144 is introduced to the pressing area 102. Moreover, an outlet chute 98 is provided downstream of the pressing area 102.

As shown in FIGS. 2 to 5B, the pressing unit 76 includes a first pressing member 114 and a second pressing member 116 constituting the pressing area 102 where pressure is applied to the heating roller 66 via the endless belt 72, a retainer 118 that retains the first pressing member 114 and the second pressing member 116, frames 126 and 127 that support the retainer 118 and the guide member 74, and a housing 124 that supports the rotation of the endless belt 72. The retainer 118 and the frames 126 and 127 of the pressing unit 76 work in cooperation with each other to support the first pressing member 114 and the second pressing member 116 such that the pressing members 114 and 116 are pressed together with the retainer 118 toward the heating roller 66.

The first pressing member 114 has substantially the same length as the retainer 118 in the longitudinal direction thereof and is composed of a heat-resistant resin material, such as silicon rubber. The second pressing member 116 also has substantially the same length as the retainer 118 in the longitudinal direction thereof and is composed of a heat-resistant resin material, such as silicon rubber. With regard to the hardness of the first pressing member 114 and the second pressing member 116, the hardness of the first pressing member 114 is higher than that of the second pressing member 116 such that the second pressing member 116 is softer than the first pressing member 114.

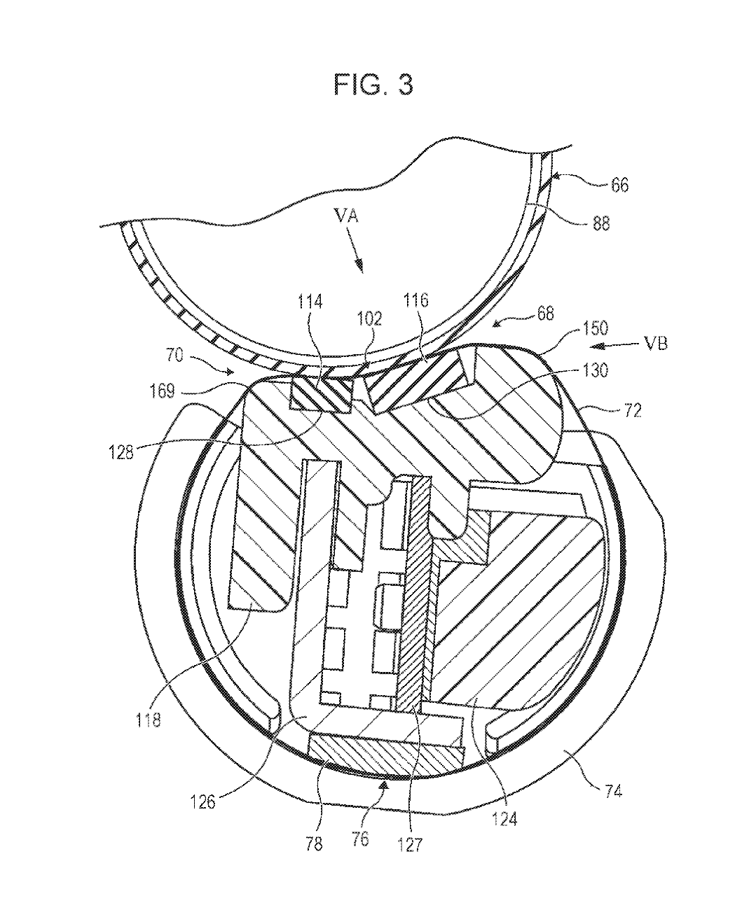

The retainer 118 is composed of, for example, glass-filled polyethylene terephthalate (PET) having high heat resistant properties. As shown in FIGS. 2 and 3, the retainer 118 has a first bearing surface 128 and a second bearing surface 130, which face the heating roller 66 and on which the first pressing member 114 and the second pressing member 116 are respectively disposed. The first bearing surface 128 and the second bearing surface 130 are formed in a recessed shape and extend in the longitudinal direction of the retainer 118. The first bearing surface 128 is formed at a downstream side 70 in the rotational direction of the endless belt 72, that is, an exit side 70 from which the recording medium 144 is to be output. The second bearing surface 130 is formed at an upstream side 68 in the rotational direction of the endless belt 72, that is, an entrance side 68 from which the recording medium 144 is to be inserted.

As shown in FIGS. 3 to 5B, at the upstream side 68 in the rotational direction of the endless belt 72, the retainer 118 has an upstream adjuster 150 that adjusts rotational behavior of the endless belt 72.

The upstream adjuster 150 extends from a surface, that is, an upper surface 152, of the retainer 118 that faces the heating roller 66 to a surface, that is, a front surface 154, located at the upstream side 68 in the rotational direction of the endless belt 72 and extending downward away from the heating roller 66. In the longitudinal direction of the retainer 118, the upstream adjuster 150 has a curved shape with an upstream-side center 156 having a bulging portion 158, which is a most bulging area from which the upstream adjuster 150 decreases in height toward opposite ends 160 and 162. With regard to the curved shape of the upstream adjuster 150, the shape changes increasingly from the bulging portion 158 at the upstream-side center 156 toward the opposite ends 160 and 162, such that the curvature increases toward the opposite ends 160 and 162 relative to the curvature at the upstream-side center 156.

The upstream adjuster 150 is also curved from the upper surface 152 toward the front surface 154.

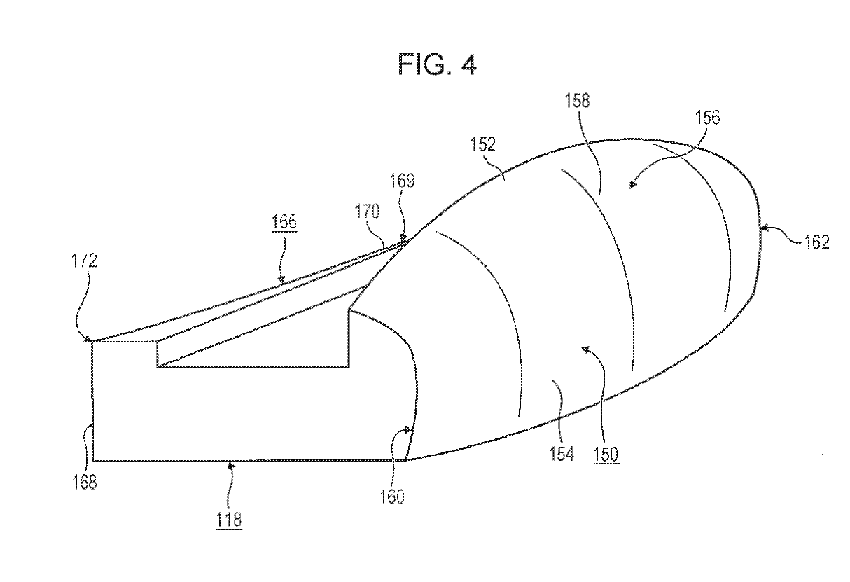

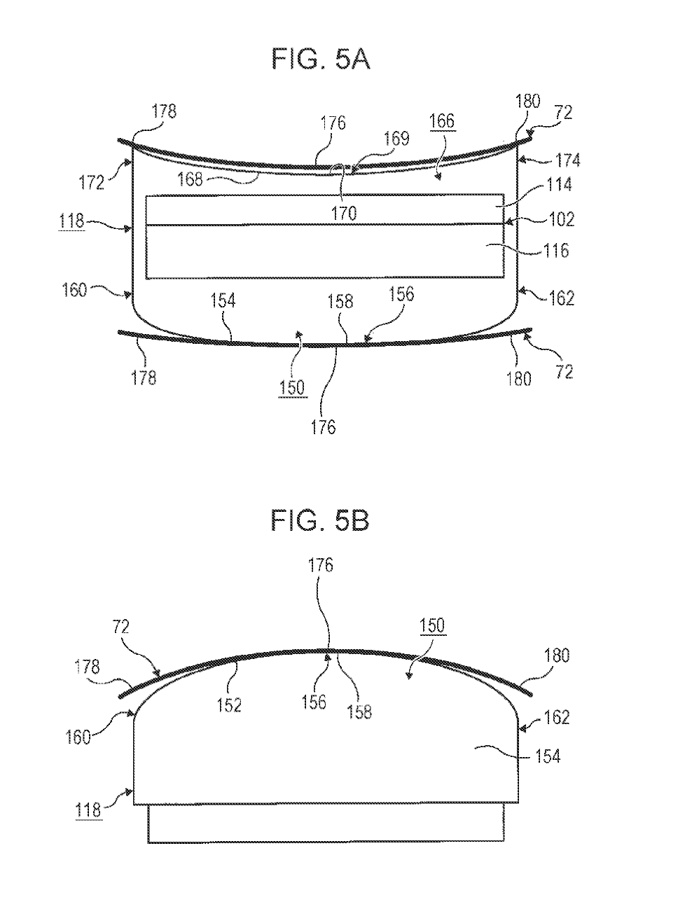

Furthermore, as shown in FIGS. 4 and 5A, the retainer 118 is provided with a downstream adjuster 166 that is located at the downstream side 70 in the rotational direction of the endless belt 72 and that adjusts the rotational behavior of the endless belt 72.

The downstream adjuster 166 is formed at a surface, that is, a rear surface 168, located at the downstream side 70 in the rotational direction of the endless belt 72 and extending downward away from the heating roller 66. In the longitudinal direction of the retainer 118, the downstream adjuster 166 has a curved shape with a downstream-side center 169 having a recessed portion 170, which is a most recessed area from which the downstream adjuster 166 increases in height toward opposite ends 172 and 174. With regard to the curved shape of the downstream adjuster 166, the shape changes increasingly from the recessed portion 170 toward the opposite ends 172 and 174, such that the curvature increases toward the opposite ends 172 and 174 relative to the curvature at the downstream-side center 169.

The frames 126 and 127 are composed of a metallic material, such as stainless steel or aluminum, and press the retainer 118 toward the heating roller 66. The frames 126 and 127 are biased toward the heating roller 66 by a biasing unit (not shown), such as a coil spring.

A member (not shown) that pivotally supports the pressing unit 76 is linked with a pressing lever. The pressing lever is biased by a biasing unit such that the pressing unit 76 applies pressure toward the heating roller 66.

The housing 124 is composed of synthetic resin, such as polyethylene terephthalate (PET), is supported by the frame 127, and supports the endless belt 72.

With regard to the fixing device 36 in the image forming apparatus 10 according to the above exemplary embodiment, the recording medium 144 having the toner image transferred thereon by the image forming unit 14 first travels along the transport path 32 so as to be transported to the pressing area 102 where the recording medium 144 is pressed by the first pressing member 114 and the second pressing member 116 of the pressing unit 76, which is where the heating roller 66 and the endless belt 72 are pressed against each other. In this case, the heating roller 66 is rotationally driven, and the endless belt 72 rotates accordingly around the outer periphery of the pressing unit 76, causing the recording medium 144 to be transported to the pressing area 102. The leading edge of the transported recording medium 144 becomes nipped between the heating roller 66 and the endless belt 72. The recording medium 144 is first pressed by the heating roller 66 and the second pressing member 116 and is subsequently pressed by the heating roller 66 and the first pressing member 114, whereby the toner image becomes fixed onto the recording medium 144.

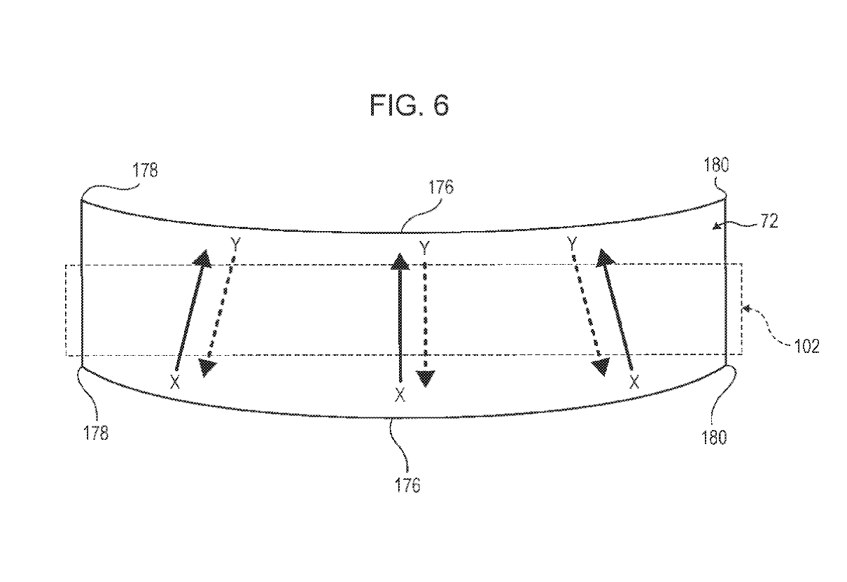

In this case, although the endless belt 72 rotates by being driven by the rotation of the heating roller 66, since the upstream adjuster 150 and the downstream adjuster 166 are formed in the retainer 118 of the fixing device 36, the endless belt 72 passing through the pressing area 102 behaves in a manner such that it moves toward a center 176 in the rotational direction, as indicated by arrows X shown in FIG. 6. On the other hand, the endless belt 72 traveling at the opposite side from the pressing area 102 behaves in a manner such that the endless belt 72 is pulled toward outer sides 178 and 180 from the center 176 in the rotational direction, as indicated by arrows Y shown in FIG. 6.

Specifically, in the process of the rotating endless belt 72 moving from the upstream side 68 toward the downstream side 70 of the pressing area 102, the center 176 of the endless belt 72 passes over the bulging portion 158 at the upstream-side center 156 of the upstream adjuster 150, which is the most bulging portion of the upstream adjuster 150, whereas the outer sides 178 and 180 of the endless belt 72 pass over the opposite ends 160 and 162 of the upstream adjuster 150, which are areas recessed in a curved shape from the upstream-side center 156. Therefore, as shown in FIGS. 5A and 5B, the endless belt 72 rotates in conformity to the shape of the upstream adjuster 150.

In the downstream adjuster 166, the center 176 of the endless belt 72 passes over the recessed portion 170 at the downstream-side center 169, which is the most recessed portion of the downstream adjuster 166, whereas the outer sides 178 and 180 of the endless belt 72 pass over the opposite ends 172 and 174 of the downstream adjuster 166, which are areas protruding upward in a curved shape from the downstream-side center 169. Therefore, as shown in FIG. 5A, the endless belt 72 rotates in conformity to the shape of the downstream adjuster 166.

As a result, due to a difference in moving speeds between the center 176 and the outer sides 178 and 180, the endless belt 72 behaves as indicated by the arrows X in FIG. 6 and moves toward the center 176 in the rotational direction. Thus, the endless belt 72 rotates while moving toward the center 176 in the rotational direction of the endless belt 72 relative to the retainer 118, so that the rotational behavior of the endless belt 72 is adjusted, thereby suppressing deviation from the center in the rotational direction.

On the other hand, in the process of the rotating endless belt 72 moving from the downstream side 70 toward the upstream side 68, the endless belt 72 behaves as indicated by the arrows Y in FIG. 6, such that the endless belt 72 moves from the center 176 toward the outer sides 178 and 180 in the rotational direction.

In the exemplary embodiment, in order to adjust the rotational behavior of the endless belt 72 of the fixing device 36, the retainer 118 is provided with the upstream adjuster 150 at the upstream side 68 in the rotational direction of the endless belt 72 and the downstream adjuster 166 at the downstream side 70 in the rotational direction of the endless belt 72. Alternatively, the retainer 118 may be provided with the upstream adjuster 150 alone or the downstream adjuster 166 alone.

Furthermore, in the exemplary embodiment, the upstream adjuster 150 for adjusting the rotational behavior of the endless belt 72 extends from the surface (i.e., the upper surface 152) of the retainer 118 that faces the heating roller 66 to the surface (i.e., the front surface 154) extending downward away from the heating roller 66. Alternatively, an upper-surface protrusion 182 that adjusts the rotational behavior of the endless belt 72 may be formed only on the surface of the retainer 118 that faces the heating roller 66, that is, the upper surface 152. As another alternative, a front-surface protrusion 190 that adjusts the rotational behavior of the endless belt 72 may be formed only on the surface of the retainer 118 that extends downward away from the heating roller 66, that is, the front surface 154.

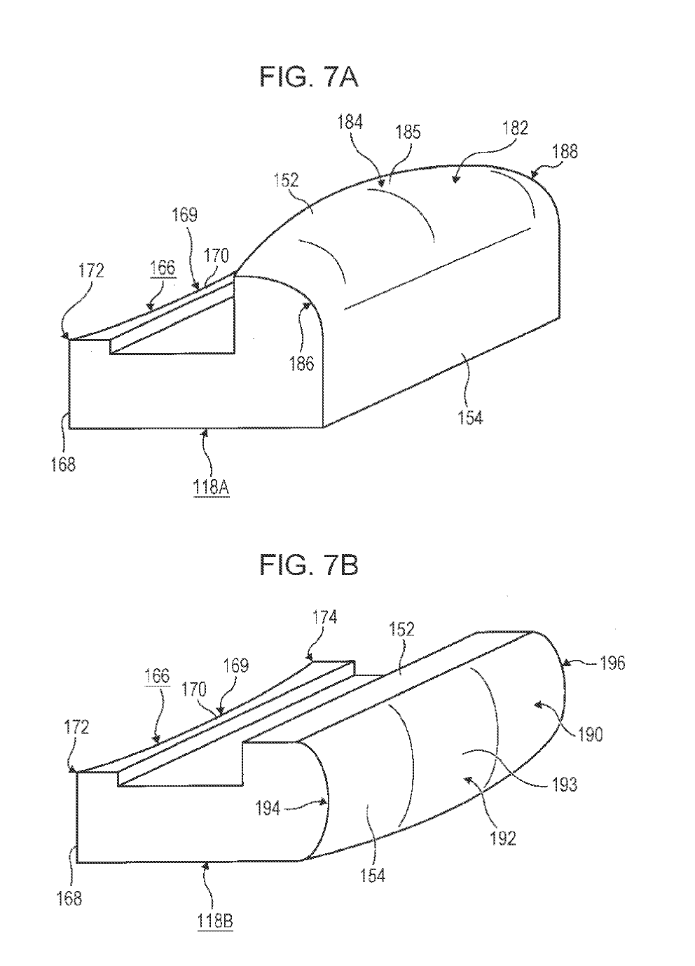

In detail, as shown in FIG. 7A, the upper-surface protrusion 182 is formed at a surface, that is, the upper surface 152, located at the upstream side 68 of a retainer 118A in the rotational direction of the endless belt 72 and facing the heating roller 66. In the longitudinal direction of the retainer 118A, the upper-surface protrusion 182 has a curved shape with an upper-surface center 184 having a bulging portion 185, which is a most bulging area from which the upper-surface protrusion 182 decreases in height toward opposite ends 186 and 188. With regard to the curved shape of the upper-surface protrusion 182, the shape changes increasingly from the bulging portion 185 at the upper-surface center 184 toward the opposite ends 186 and 188. Furthermore, the upper-surface protrusion 182 may be provided by forming the surface extending downward away from the heating roller 66 into a curved surface. Although the above-described downstream adjuster 166 is formed in addition to the upper-surface protrusion 182 in FIG. 7A, the exemplary embodiment of the present invention is not limited to this. Alternatively, the upper-surface protrusion 182 alone may be formed.

Furthermore, as shown in FIG. 7B, the front-surface protrusion 190 is formed at a surface, that is, the front surface 154, located at the upstream side 68 of a retainer 118B in the rotational direction of the endless belt 72 and extending downward away from the heating roller 66. In the longitudinal direction of the retainer 118B, the front-surface protrusion 190 has a curved shape with a front-surface center 192 having a bulging portion 193, which is a most bulging area from which the front-surface protrusion 190 decreases in height toward opposite ends 194 and 196. With regard to the curved shape of the front-surface protrusion 190, the shape changes increasingly from the front-surface center 192 toward the opposite ends 194 and 196. Furthermore, the front-surface protrusion 190 may be provided by forming the surface facing the heating roller 66 into a curved surface. Although the above-described downstream adjuster 166 is formed in addition to the front-surface protrusion 190 in FIG. 7B, the exemplary embodiment of the present invention is not limited to this. Alternatively, the front-surface protrusion 190 alone may be formed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A fixing device comprising:
a pressure applying unit that is provided facing a heating unit,
wherein the pressure applying unit includes
an endless belt-shaped member that rotates by being driven by rotation of the heating unit, and
a retainer that retains the endless belt-shaped member in a movable manner,
wherein the retainer has an upstream adjuster that is located at an upstream side of the retainer with respect to a rotational direction of the endless belt-shaped member and that has a curved shape with a center, in a longitudinal direction of the retainer, which is a most bulging area from which the upstream adjuster decreases in height toward opposite ends of the upstream adjuster in the longitudinal direction, and
wherein the upstream adjuster is separated from the heating unit such that no point along the endless belt-shaped member is simultaneously contacted by the upstream adjuster and the heating unit.

2. The fixing device according to claim 1,
wherein the curved shape of the upstream adjuster changes increasingly toward the opposite ends.

3. The fixing device according to claim 1,
wherein a curved surface that is located at an upstream side of the upstream adjuster with respect to the rotational direction of the endless belt-shaped member extends from a side facing the heating unit to a surface extending downward away from the heating unit.

4. The fixing device according to claim 1,
wherein the retainer further has a downstream adjuster that is located at a downstream side of the retainer with respect to the rotational direction of the endless belt-shaped member and that has a curved shape with a downstream-side center, in the longitudinal direction of the retainer, which is a most recessed area from which the downstream adjuster increases in height toward opposite ends of the downstream adjuster in the longitudinal direction.

5. The fixing device according to claim 4,
wherein the curved shape of the downstream adjuster changes increasingly toward the opposite ends.

6. A fixing device comprising:
a pressure applying unit that is provided facing a heating unit,
wherein the pressure applying unit includes
an endless belt-shaped member that rotates by being driven by rotation of the heating unit, and
a retainer that retains the endless belt-shaped member in a movable manner,
wherein the retainer has a downstream adjuster that is located at a downstream side of the endless belt-shaped member in a rotational direction thereof and that has a curved shape with a downstream-side center, in a longitudinal direction of the retainer, which is a most recessed area from which the downstream adjuster increases in height toward opposite ends of the downstream adjuster.

7. The fixing device according to claim 6,
wherein the curved shape of the downstream adjuster changes increasingly toward the opposite ends.

8. An image forming apparatus comprising:
the fixing device according to claim 1.
